(19) United States
(12) Patent Application Publication
(10) Pub. No.: US 2008/0086842 A1
(43) Pub. Date: Apr. 17, 2008

(54) Door knob adapter

(76) Inventors: Douglas C. Dayton, Harvard, MA (US); Timothy Moulton, Newport, RI (US); Sung K. Park, Waban, MA (US)

Correspondence Address: Carol H. Peters;Mintz, Levin, Cohn, Ferris, Glovsky and, Popeo, P.C., One Financial Center, Boston, MA, 02111, US

(21) Appl. No.: 11/893,146

(22) Filed: Aug. 14, 2007

Related U.S. Application Data
(60) Provisional application No. 60/838,039, filed on Aug. 15, 2006.
(60) Provisional application No. 60/843,094, filed on Sep. 8, 2006.

(51) Int. Cl. E05B 1/00

(52) U.S. Cl. 16/412

(57) ABSTRACT

An adapter for a door knob is provided comprising a lever handle including a base plate and a handle portion, a clamp, and a tightening band. The clamp is disposed along or attached to the base plate and is constructed and arranged to engage with at least a portion of a door knob or at least a portion of a supporting shaft, stalk or rotation axis of a door knob such that the lever handle extends transversely to the axis of the clamp. The clamp includes at least a portion of an inner surface adapted to frictionally engage to the portion of the door knob or supporting shaft, stalk or rotation axis. The tightening band is attached to the lever handle and is adapted to be tightened or otherwise adjusted around at least a portion of the supporting shaft, stalk or rotation axis, or around at least a portion of a door knob, by a tightening mechanism to help to achieve a non-slip fit and attachment of the lever handle to the supporting shaft, stalk or rotation axis or to the door knob. When the adapter is assembled and connected to a door knob or to a supporting shaft, stalk or rotation axis of a door knob, the lever handle may be actuated by force or torque an end-user applies to the lever handle which thereby releases or otherwise actuates an associated latch mechanism without undue effort by the end-user.

### PRIOR APPLICATIONS

This application is a non-provisional patent application claiming priority to U.S. provisional patent application Ser. No. 60/838,039 filed on Aug. 15, 2006 and U.S. provisional patent application Ser. No. 60/843,094 filed on Sep. 8, 2006, each of the disclosures of which is incorporated herein in its entirety by reference.

### FIELD OF THE INVENTION

Embodiments of the present invention are directed to a door knob adapter, and more particularly to a lever handle adapter for use on new or previously installed door knobs or supporting shafts, stalks or rotation axes of doors knobs for rotation or actuation of such doors knobs or supporting shafts, stalks or rotation axes without undue effort.

### BACKGROUND OF THE INVENTION

Most people take for granted the ease with which they open doors and, in particular, open doors that are equipped with the ubiquitous circular or rounded door knob. For a growing proportion of the population however all types of door knobs can pose difficulties and potentially serious problems with respect to navigating rooms and buildings. More specifically, older and elderly people tend to loose muscle mass, dexterity and consequently hand grip ability and strength with age such that actuating, rotating or turning a door knob may be difficult or impossible. In addition, many people are afflicted with arthritis that affects their manual strength and ability to grip or grasp and to rotate or otherwise actuate a door knob. Further, children with small hands may encounter difficulties in reaching and grasping and in rotating or actuating a door knob.

### SUMMARY OF THE INVENTION

Considering a substantial number of new or existing door knobs are of the circular or rounded type, changing such door hardware in any particular residence or building to accommodate the occupants who have compromised abilities and strength to turn, rotate or otherwise actuate door knobs is an expensive and time-consuming proposition. The present invention provides a door knob adapter that may be attached to a new or previously installed door knob or a supporting shaft, stalk or rotation axis of a door knob to provide a lever handle for releasing or otherwise actuating an associated door latch mechanism with ease and comfort.

A first aspect of the invention is directed to an adapter for a door knob having a supporting shaft, stalk or rotation axis, the adapter comprising a split lever handle including a base plate and a first lever and a second lever pivotally connected to the base plate by a pivoting cam such that at least the first lever pivots about a pivot of the pivoting cam; a collar clamp disposed along one end of the base plate, wherein the split lever handle extends transversely to the axis of the collar clamp; the collar clamp adapted to engage with the supporting shaft, stalk or rotation axis; a tightening band attached to the base plate such that the tightening band clamps around at least a portion of the supporting shaft, stalk or rotation axis; and a locking tab disposed along the base plate and adapted to receive at least a portion of the tightening band and to lock with the portion of the tightening band.

Implementations of the invention may include one or more of the following features. When tightened or otherwise adjusted around the portion of supporting shaft, stalk or rotation axis, the tightening band and the collar clamp cause the lever handle to have a fixed positive relation to the supporting shaft, stalk or rotation axis. When the first lever pivots to a locked position, the pivoting cam pivots simultaneously to a locked position. When in the locked position, the pivoting cam engages with the tightening band to help to tighten the tightening band about the supporting shaft, stalk or rotation axis. The tightening band is integral with the locking tab. The locking tab is adapted for removable insertion of the portion of the tightening band into the locking tab. The tightening band includes one or more serrated edges for locking with the locking tab.

Implementations of the invention may also include one or more of the following features. At least a portion of an inner surface of the collar clamp is adapted to cause the inner surface to frictionally engage with a surface of the supporting shaft, stalk or rotation axis of the door knob. The portion of the inner surface of the collar clamp includes a material, a coating or other treatment to adapt the inner surface to serve as a gripping surface to promote friction between the inner surface and the supporting shaft, stalk or rotation axis of the door knob. The material includes a material selected from the group consisting of elastomeric material, rubber, synthetic rubber, adhesive, high friction chemical application, and any combinations thereof. The portion of the inner surface of the collar clamp includes a textured, scored, knurled, brushed, pitted or other treated surface to promote friction between the inner surface and the supporting shaft, stalk or rotation axis of the door knob.

In general, in another aspect, the invention is directed to an adapter for a door knob having a supporting shaft, stalk or rotation axis, the adapter comprising a lever handle including a base plate and a handle portion; a split collar clamp attached to one end of the base plate, wherein the handle portion extends transversely to the axis of the split collar clamp; the split collar clamp adapted to frictionally engage to the supporting shaft, stalk or rotation axis; a screw band attached to the base plate proximate to the split collar clamp such that where the split collar clamp engages the supporting shaft, stalk or rotation axis, the screw band clamps around at least a portion of the supporting shaft, stalk or rotation axis, the screw band adapted to be tightened or otherwise adjusted around the portion of the supporting shaft, stalk or rotation axis; and a tightening screw disposed in the base plate to engage the screw band and adapted to tighten or to otherwise adjust the screw band.

Implementations of the invention may include one or more of the following features. When tightened or otherwise adjusted around the portion of the supporting shaft stalk or rotation axis, the screw band and the split collar clamp cause the lever handle to have a fixed positive relation to the supporting shaft, stalk or rotation axis of the door knob. The base plate includes a clamp housing in which at least a portion of the tightening screw resides, the clamp housing adapted to permit the screw band to engage with the tightening screw. The clamp housing is an integral portion of the base plate. The clamp housing is adapted to be removably connected to at least a portion of the base plate. The tightening screw is disposed and is adapted to permit access to a tightening feature of the tightening screw from an area external to the base plate. The split collar clamp is adapted to be removably attached to the one end of the base plate. The clamp housing is adapted to be removably attached to the base plate. The screw band is adapted to be removably attached to the base plate. The screw band is permanently attached to the base plate. The split collar clamp is permanently attached to the one end of the base plate.

Implementations of the invention may also include one or more of the following features. At least a portion of an inner surface of the split collar clamp includes a material, a coating or other treatment to adapt the portion to serve as a gripping surface to promote friction between the inner surface and the supporting shaft, stalk or rotation axis of the door knob. The material includes a material selected from the group consisting of elastomeric material, rubber, synthetic rubber, adhesive, high friction chemical application, and any combinations thereof. The portion of the inner surface of the split collar clamp is a textured, scored, knurled, brushed, pitted, or other treated surface to promote friction between the inner surface and the supporting shaft, stalk or rotation axis of the door knob. An appearance cap is adapted to attach to the lever handle. An appearance cap is adapted to attach to the slit collar clamp.

In general, in another aspect, the invention is directed to an adapter for a door knob having a supporting shaft, stalk or rotation axis, the adapter comprising a lever handle including a base plate and a handle portion; a screw band attached to the base plate, wherein the handle portion extends transversely to the axis of the screw band; a finger shell adapted to attach to at least a portion of the door knob, the finger shell including multiple attachment fingers, wherein one or more attachment fingers includes at least a portion of an inner surface adapted to cause the attachment finger and the finger shell to frictionally engage to the portion of the door knob; the finger shell further adapted to receive the screw band to attach the lever handle to the finger shell; and a tightening screw attached to the screw band and adapted to tighten or to otherwise adjust the screw band about the finger shell.

Implementations of the invention may include one or more of the following features. The finger shell and the one or more attachment fingers cause the lever handle to have a fixed positive relation to the door knob and its supporting shaft, stalk or rotation axis. The screw band includes a screw boss attached to the screw band and adapted to house the tightening screw, and wherein the base plate of the lever handle includes an indenture or depression configured to receive at least a portion of the screw boss to connect the screw band to the base plate. The screw boss provides a path to convey force or torque applied to the lever handle to the door knob. The finger shell includes one or more registration features, each registration feature being disposed and configured such that at least a portion of the registration feature engages with at least a portion of one of multiple complementary locking features disposed along the base plate to attach the level handle with the finger shell. The one or more registration features include one or more protrusions or tabs and the complementary locking features including one or more indentures or slots.

Implementations of the invention may also include one or more of the following features. The portion of the inner surface of one or more attachment finger includes a material, a coating or other treatment to adapt the inner portion to serve as a gripping surface to promote friction between the inner surface and the door knob. The material includes a material selected from the group consisting of an elastomeric material, rubber, synthetic rubber, adhesive, high friction chemical application, and any combinations thereof. The portion of the inner surface of one or more attachment finger is a textured, scored, knurled, brushed, pitted, or other treated surface to promote friction between the inner surface and the door knob.

Capabilities and advantages of the invention may include one or more of the following. An economical and efficient alternative can be provided to retrofit or to alter door knobs with a lever handle type adapter for actuating associated door latch mechanisms, wherein such lever handle type adapter is constructed and arranged to accommodate the varying manual abilities and hand sizes of people. A new, existing or previously installed door knob can be retrofitted with a single lever handle adapter to provide a surface or an appendage to which an end-user may apply force or torque using their hand or another article with ease of movement and without discomfort to release or to otherwise actuate an associated door latch mechanism. The lever handle adapter can be constructed and arranged for attachment to a new, existing or previously installed door knob, or to the supporting shaft, stalk or rotation axis of such door knob, with a screw mechanism using a screwdriver. Alternatively, the lever handle adapter can be constructed and arranged for attachment to a supporting shaft, stalk or rotation axis of a new, existing or previously installed door knob without requiring the use of any tool(s). The lever handle adapter can include a friction surface associated with a clamp that surrounds or otherwise engages with at least a portion of a door knob, or at least a portion of a supporting shaft, stalk or rotation axis of a door knob, to help to provide a non-slip fit and attachment of the adapter. The clamp can be tightening or otherwise adjusted using a tightening band to secure and to retrofit the lever handle adapter to a door knob or to a supporting shaft, stalk or rotation axis of a door knob. The tightening band encircles or surrounds at least a portion of a door knob or a supporting shaft, stalk or rotation axis of a door knob, and, in some instances, at least a portion of the clamp, to clamp around the portion of the door knob or the supporting shaft, stalk or rotation axis. In one instance, the tightening band can include a screw band, e.g., a metal or plastic screw band, constructed and arranged to be tightened or otherwise adjusted using a screw mechanism and a screwdriver. In another instance, the tightening band can include a band, e.g., a metal or plastic band, constructed and arranged to be tightened or otherwise adjusted using a locking tab adapted to receive and to lock with at least a portion of the tightening band when the portion of the tightening band and the locking tab are engaged. In this case, the metal or plastic band can include one or more serrated edges. An appearance cap or shell can be connected to portions of the lever handle adapter to cover such portions and to provide an aesthetically-pleasing and/or finished appearance of the adapter when assembled and installed. The lever handle adapter can include a minimum number of components or parts and can be constructed and arranged for intuitive assembly and attachment to a door knob or a door knob supporting shaft, stalk or rotation axis. The lever handle adapter can be assembled and connected to a new, existing or previously installed door knob or supporting shaft, stalk or rotation axis of a door knob without changing or removing door knob hardware. Removal and replacement of door hardware are eliminated or minimized in achieving easily-actuated door latch mechanisms, resulting in savings with respect to costs for parts and installation. Other capabilities and advantages are within the scope of the invention.

The invention will be more fully understood after a review of the following figures, detailed description and claims.

### BRIEF DESCRIPTION OF THE DRAWINGS

FIG. 1 is an exploded perspective view of certain structural components of a door knob adapter according to the invention;

FIG. 2A is a perspective view of the structure of another door knob adapter according to the invention;

FIG. 2B is a perspective view of the opposing side of the door knob adapter shown in FIG. 2A;

FIG. 2C is a perspective view of the door knob adapter shown in FIG. 2B attached to a supporting shaft, stalk or rotation axis of a door knob;

FIG. 3A-3E are perspective views of alternate configurations of a lever handle of the door knob adapter shown in FIG. 1, shown in FIGS. 2A-2C, and shown in FIGS. 4 and 5;

FIG. 4 is an exploded perspective view of certain structural components of a door knob adapter according to the invention;

FIG. 5 is an exploded perspective view of certain structural components of another door knob adapter according to the invention;

FIGS. 6A-6C includes section views of certain structural components of another door knob adapter according to the invention; and

FIG. 7 is a block diagram of a method of adapting a door knob and/or its supporting shaft, stalk or rotation axis.

### DETAILED DESCRIPTION OF THE INVENTION

Embodiments of the invention provide a lever handle door knob adapter constructed and arranged for attachment to a new or a previously installed door knob, wherein the adapter attaches to the door knob or to a supporting shaft, stalk or rotation axis of the door knob. The adapter includes a lever handle, a clamp, and a tightening band. The clamp has a high friction surface that engages a surface of the door knob or a surface of the door knob shaft, stalk or rotation axis with a relatively high coefficient of friction to help to achieve a non-slip fit and attachment of the lever handle to the door knob or its shaft, stalk or rotation axis. The clamp is further adapted to attach to a base plate of the lever handle. Alternatively, the clamp is an integral portion of the lever handle. The tightening band is configured to surround and to clamp around the clamp and to be tightened or otherwise adjusted around the clamp to help to achieve a non-slip fit and attachment of the lever handle to the door knob or to the supporting shaft, stalk or rotation axis of a door knob. Alternatively, or additionally, the tightening band is configured to surround and to clamp around at least a portion of the supporting shaft, stalk or rotation axis of a door knob to help to achieve a non-slip fit and attachment of the lever handle to the shaft, stalk or rotation axis. The tightening band may include a metal or plastic screw band constructed and arranged for tightening or otherwise adjusting around the clamp, and/or at least a portion of a supporting shaft, stalk or rotation axis of a door knob, by a screw mechanism. Alternatively, the tightening band may include a metal or plastic band constructed and arranged for tightening or otherwise adjusting around the clamp, and/or at least a portion of a supporting shaft, stalk or rotation axis of a door knob, by engaging with a locking tab. When the adapter is attached to a door knob or to the supporting shaft, stalk or rotation axis of a door knob, the lever handle is disposed in a fixed positive relation to the door knob or to the shaft, stalk or rotation axis. The lever handle serves as a surface or an appendage that receives force or torque an end-user applies to rotate or otherwise to actuate the door knob or the shaft, stalk or rotation axis to thereby release or otherwise actuate an associated latch mechanism without undue effort by the end-user. Further embodiments of the invention are possible and envisioned.

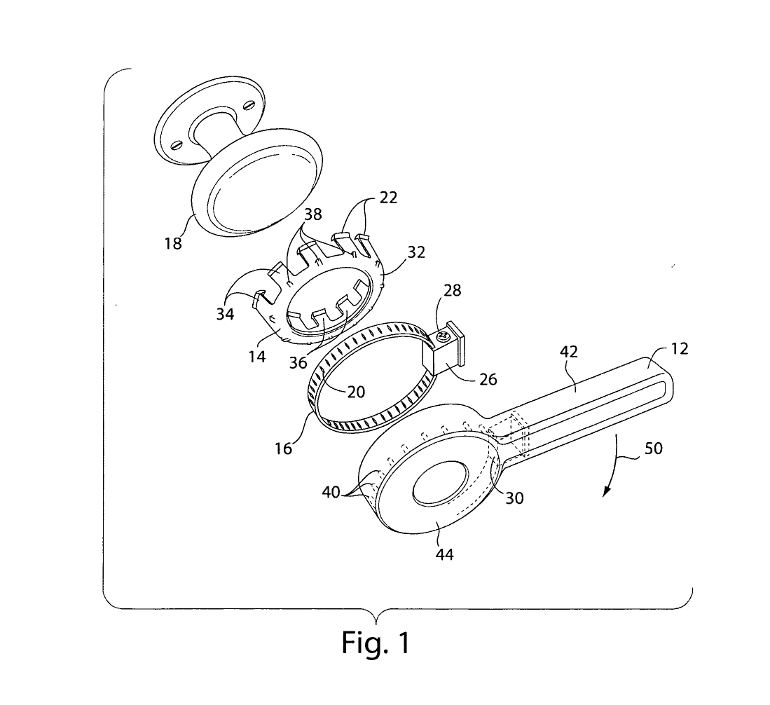

Referring to FIG. 1, in an aspect, the invention provides a door knob adapter 10 including a lever handle 12, a finger shell 14, and a tightening clamp 16. The finger shell 14 is configured to receive at least a portion of a door knob 18 and to thereby slip over the door knob portion to serve as a base to which the clamp 16 is attached to the door knob 18. The tightening clamp 16 includes a screw band 20, e.g., constructed of metal or plastic, configured to surround and to clamp around the finger shell 14. A plurality of protrusions 22 is disposed along the finger shell 14 and such protrusions 22 are configured to help to retain the clamp 16 to the finger shell 14. The tightening clamp 16 further includes a tightening screw 28 residing within a screw boss 26 attached to and projecting from the screw band 20. The tightening screw 28 is disposed and is configured to tighten or to otherwise adjust the screw band 20 to the finger shell 14. The screw boss 28 is disposed and is configured such that a detent 30 that is defined in the lever handle 12 receives at least a portion of the screw boss 28 to register the lever handle 12 to the clamp 16 and to thereby attach the lever handle 12 to the finger shell 14. The screw boss 28 further provides a load path that transfers force or torque that an end-user applies to the lever handle 12 to the door knob 18 during operation of the adapter 10 such that the door knob 18 is rotated or otherwise actuated. A latch mechanism (not shown) associated with the door knob 12 is thereby actuated or released.

As shown in FIG. 1, the finger shell 14 is configured to slip over and to fit to a range of sizes of door knobs 18 and, in particular, a range of diameters of door knobs 18 such that the finger shell 14 receives at least a portion of a door knob 18 to attach the finger shell 14 to the door knob 18. Preferably, the finger shell 14 is configured to fit to a door knob having a rounded or circular configuration and/or other configurations including, but not limited to, an oval, elliptical, tear drop, conical, oblate, pentagonal, hexagonal, and spherical shaped door knob.

The finger shell 14 includes a front face portion 32 and a plurality of attachment fingers 34 extending from the front face portion 32. The front face portion 32 is constructed of one or more materials such that the front face portion 30 is a relatively non-flexing and relatively rigid portion of the finger shell 14. The plurality of attachment fingers 34 is constructed of one or more materials to configure the attachment fingers 34 as flexible features that engage at least a portion of the door knob 18, e.g., an outer diameter or an outer perimeter portion of the door knob 18, to facilitate attachment of the finger shell 14 to the door knob 18. The one or more materials of the attachment fingers 34 help to enable the finger shell 14 to engage and to attach to the door knob 18 with a relatively high coefficient of friction. In addition, one or more of the attachment fingers 34 can be sized and shaped or otherwise configured to help to mate at least a portion of each attachment finger 34 to a surface of the door knob 18. The finger shell 14 helps to achieve a non-slip fit and attachment of the finger shell 14 and the adapter 10 to the door knob 18.

One or more of the attachment fingers 34 can include an inner surface 36 that engages with a surface of the door knob 18 with a relatively high coefficient of friction to help to enable the inner surface 36 to serve as a gripping surface that helps to achieve the non-slip fit and attachment of the finger shell 14 and the adapter 10 to the door knob 18. The inner surface 36 can achieve such friction with a surface of the door knob 18 with a material, a coating or other treatment applied to at least a portion of the inner surface 36. In one instance, a material can include one or more materials suitable for creating a gripping surface, including, but not limited to, elastomeric material, rubber, synthetic rubber, adhesive, high friction chemical application, and any combinations thereof. In addition, in another instance, the attachment finger 34 itself can be wholly or partially constructed of one or more of such materials to enable the inner surface 36 to serve as a gripping surface that provides friction with a surface of the door knob 18. Alternatively, or additionally, the inner surface 36 can define a textured, scored, knurled, brushed, pitted or other treated surface configured to help to provide a gripping surface and to promote friction between the inner surface 36 and a surface of the door knob 18. Optionally, a material, a coating or other treatment can be applied to a surface of the door knob 18 to help to increase the friction between the inner surfaces 36 of any of the attachment fingers 34 and the surface of the door knob 18. The non-slip fit and attachment of the finger shell 14 to the door knob 18 helps to enable the rotation or otherwise the actuation of the door knob 18 using the lever handle 12 when the adapter 10 is assembled and connected to the door knob 18.

The finger shell 14 further includes along an outer surface the plurality of protrusions 22 or other configurations each of which are disposed and configured to engage with and to help to retain the screw band 20 to the finger shell 14. As shown in FIG. 1, each protrusion 22 can include a tab or other raised configuration.

The finger shell 14 further includes, along a surface of the front face portion 33, a plurality of registration features 38 that are relatively non-flexing locking elements disposed and configured to fit with or to otherwise engage a plurality of complementary locking features 40 that the lever handle 12 defines to register the lever handle 12 to the finger shell 14. The registration features 38 are constructed of one or more materials that are relatively rigid and relatively non-flexing. Each registration feature 38 can be configured such that at least a portion of the registration feature 38 and at least a portion of a complementary locking feature 40 engage to create a locking combination to secure the lever handle 12 to the finger shell 14. As shown in FIG. 1, the locking combination can include one or more registration features configured as a protrusion or tab 38 of which at least a portion is received by a complementary locking feature configured as an indenture, a slot, or other depression 40 defined along the lever handle 12. The complementary indenture, slot or other depression 40 is sized and is shaped such that at least a portion of the protrusion or tab 38 fits securely therein. The invention is not limited in this respect and envisions other configurations of the registration features 38 and the complementary locking features 40 to create locking combinations that facilitate attachment and assembly of the lever handle 12 to the finger shell 14.

With further reference to FIG. 1, as mentioned above, the clamp 16 includes the screw band 20, the screw boss 20 attached to the screw band 20, and the tightening screw 28 housed within the screw boss 20. The screw band 20 is configured to surround and to clamp to the finger shell 14 by tightening or otherwise adjusting the screw band 20 using the tightening screw 28. The screw band 20 thereby mates with a surface of the finger shell 14 and is retained to the finger shell 14 by the resulting tension and the plurality of protrusions 22. As shown in FIG. 1, the screw band 20 defines a circular profile to accommodate a rounded or circular shape of the door knob 18, as well as other door knob configurations including, but not limited to, an oval, elliptical, tear drop, conical, oblate, pentagonal, hexagonal, and spherical shaped door knob. The invention however is not limited to any particular configuration of the screw band 20 and anticipates that the screw band 20 can define other configurations to accommodate any of a variety of shapes and/or sizes of door knobs.

The screw boss 26 is sized and is shaped to house the tightening screw 28 and to enable the detent 30 of the lever handle 40 to receive at least a portion of the screw boss 26 such that the screw boss 26 fits securely therein. The lever handle 12 is thereby attached to the clamp 16 and to the finger shell 14. As mentioned above, the screw boss 28 provides a load path that transfers force or torque that an end-user applies to the lever handle 12 to the door knob 18 during operation of the adapter 10. The applied force or torque rotates or otherwise actuates the door knob 18 to thereby release or otherwise actuate a latch mechanism associated with the door knob 18. Such force or torque can include, for instance, a downward movement of the lever handle 12, as shown by arrow 50 in FIG. 1.

The lever handle 12 includes, as mentioned above, the detent 30 for receiving at least a portion of the screw boss 26 to register the lever handle 12 to the clamp 16, and the plurality of locking features 40 that complement the plurality of registration features 38 of the finger shell 14. The lever handle 12 further includes a handle portion 42 and a base plate 44. The base plate 44 defines a size and a shape such that at least a portion of the base plate 44 receives at least a portion of the door knob 18 or, more particularly, receives at least a portion of the door knob 18 with the finger shell 14 and the clamp 16 attached to the door knob 18. The plurality of locking features 40 are defined along an inner surface of the body plate 44.

Where the body plate 44 fits over the door knob 18, at least a portion of the screw boss 26 is received by the detent 30 and at least a portion of at least one registration feature 38 is received by a locking feature 40 to register the lever handle 12 to the finger shell 14 and thereby to the door knob 18. As a result, the lever handle 12 is attached to the door knob 18 such that the handle portion 42 extends transversely from an axis of the base plate 44. The frictionally attached finger shell 14, secured with the screw band 20, causes the adapter 10 and, more specifically, the lever handle 12, to have a fixed positive relation to the door knob 18, and/or a supporting shaft, stalk or rotation axis of the door knob 18, to allow the door knob 18 and/or its shaft, stalk or rotation axis to rotate or to otherwise actuate as a result of an end-user applying force or torque to the handle portion 42, e.g., by pushing the handle portion 42 in a downward movement as shown by arrow 50 in FIG. 1, to thereby actuate or release a latch mechanism associated with the door knob 18 without undue effort.

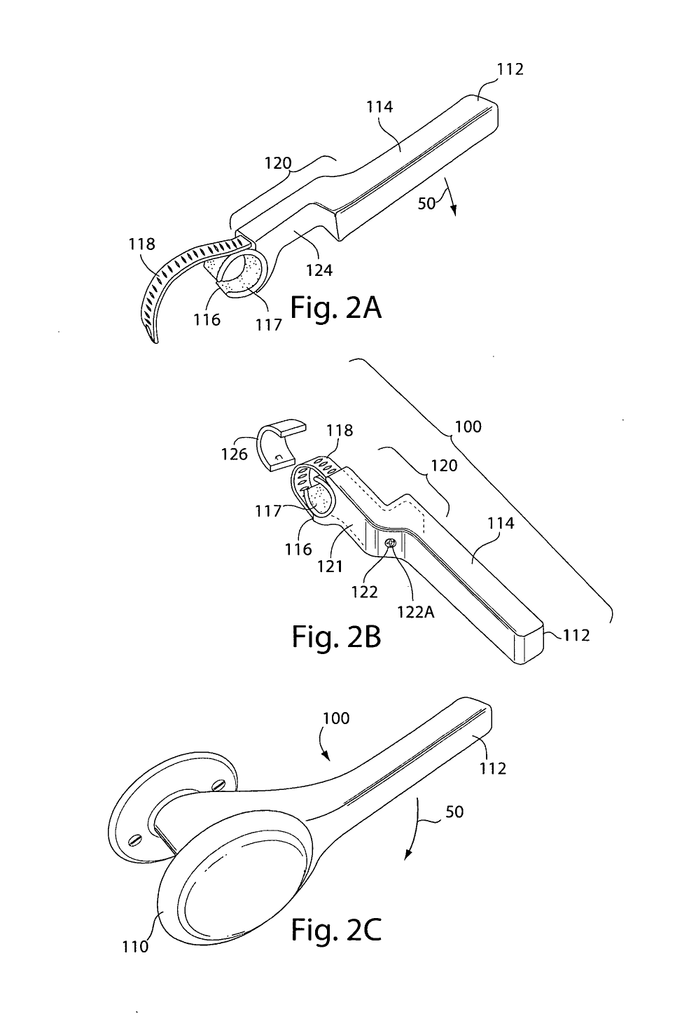

Referring to FIGS. 2A-2C, in another aspect, the invention provides a door knob adapter 100 for attachment to a supporting shaft, stalk or rotation axis (not shown) of the door knob 18. The adapter 100 can be attached to a supporting shaft, stalk or rotation axis with or without the door knob attached. Where the door knob 18 is attached to its supporting shaft, stalk or rotation axis, the adapter 100 is constructed and arranged such that a latch mechanism associated with the door knob 18 can be actuated by the adapter 100 or by the door knob 18. The adapter 100 provides an end-user with a surface or an appendage that the end-user may apply force or torque to in order to rotate or to otherwise actuate the door knob 110 and thereby the door knob's 110 associated latch mechanism without undue effort.

As shown in FIG. 2A, the adapter 100 includes a lever handle 112 with a handle portion 114 and a base plate 120. The handle portion 114 is disposed along one end of the lever handle 112 and a split collar clamp 116 is disposed along an opposite end of the handle portion 114 and is attached to the base plate 120. The split collar clamp 116 is shaped and is sized to surround and to clamp around the supporting shaft, stalk or rotation axis of the door knob 110 to help to connect the lever handle 112 to the door knob 110.

At least a portion of an inner surface 117 of the split collar clamp 116 can include a surface that engages with a surface of a door knob 110 supporting shaft, stalk or rotation axis with a relatively high coefficient of friction to enable the inner surface 117 to serve as a gripping surface that helps to achieve a non-slip fit and attachment of the split collar clamp 116 and the adapter 100 to the supporting shaft, stalk or rotation axis.

The inner surface 117 can provide such friction with a surface of the supporting shaft, stalk or rotation axis by applying a material, a coating or other treatment to at least a portion of the inner surface 117. In one instance, the material can include one or more materials suitable for creating a gripping surface, including, but not limited to, an elastomeric material, rubber, synthetic rubber, adhesive, high friction chemical application, and any combinations thereof. In addition, in another instance, the split collar clamp 116 itself can be wholly or partially constructed of one or more of such materials to enable the inner surface 117 to serve as a gripping surface that provides friction with a surface of the door knob 110 supporting shaft, stalk or rotation axis.

Alternatively, or additionally, the inner surface 117 can define a textured, scored, knurled, brushed, pitted or other treated surface configured to help to provide a gripping surface and to promote friction between the inner surface 117 and a surface of the door knob 110 supporting shaft, stalk or rotation axis. Optionally, a material, a coating or other treatment can be applied to a surface of the door knob 110 supporting shaft, stalk or rotation axis to help to increase the friction between the inner surfaces 117 and the surface of the supporting shaft, stalk or rotation axis. The non-slip fit and attachment of the split collar clamp 116 to the door knob 110 supporting shaft, stalk or rotation axis helps to enable the rotation or otherwise the actuation of the shaft, stalk or rotation axis using the lever handle 112 when the adapter 100 is assembled and connected to the door knob 110 supporting shaft, stalk or rotation axis.

With further reference to FIG. 2A, the lever handle 112 further includes a tightening band 118, e.g., a metal or plastic screw band, that is attached to the lever handle 112 at the base plate 120. One end of the tightening 118 is free and unattached, while an opposing end is attached to the base plate 120. The screw band 118 is sized, e.g., defines a width and a length, that permits the screw band to substantially encircle and to clamp around the supporting shaft, stalk or rotation axis of the door knob 110, and to further clamp around the split collar clamp 116 when the clamp 116 is attached to shaft, stalk or rotation axis.

As shown in FIG. 2B, the screw band 118 has sufficient length to substantially encircle and to clamp around the split collar clamp 116, as described, and to be fed into and received by a clamp housing 121 that the base plate 120 defines within the base plate 120 interior. The clamp housing 121 is disposed and adapted to receive at least a portion of the screw band 118 as the band 118 is fed into and received by the housing 121. The clamp housing 121 is further adapted to permit the screw band 118 to engage with a tightening screw 122, at least a portion of which resides within the clamp housing 121 and the base plate 120. Once the screw band 118 is engaged with the tightening screw 122, the tightening screw 122 is rotated or otherwise actuated to tighten or to adjust the screw band 118 around a supporting shaft, stalk or rotation axis of the door knob 110 to thereby clamp the screw band 118 around the split collar clamp 116. The tightening screw 112 is disposed and is adapted to permit access to and to enable tightening or actuation of the screw 112 from an area external to the housing 121 and the base plate 120. The tightening screw 112 may include a tightening feature 122A used to rotate or otherwise actuate the screw 112. As shown in FIG. 2B, the tightening screw 112 may be accessed with a screwdriver during assembly and attachment of the adapter 100 to the door knob 110 supporting shaft, stalk or rotation axis.

The adapter 100 is attached to the supporting shaft, stalk or rotation axis such that the handle portion 114 extends transversely from an axis of the split collar clamp 116. The frictionally attached split collar clamp 116, secured by the screw band 118, causes the adapter 100 and, more specifically, the handle portion 114 to have a fixed positive relation to the door knob 110 supporting shaft, stalk or rotation axis to allow the shaft, stalk or rotation axis to rotate or to otherwise actuate as a result of an end-user applying force or torque to the handle portion 114, e.g., by pushing the handle portion 114 in a downward movement as shown by arrow 50 in FIG. 2C, to thereby actuate or release a latch mechanism associated with the door knob 110 without undue effort.

As shown in FIG. 2C, and with further reference to FIG. 2A, where the adapter 100 is attached to the supporting shaft, stalk or rotation axis of the door knob 110, the lever handle 112 accommodates a shape and/or a size of the door knob 110 due to one or more cut-outs or depressions 124 defined along the lever handle 112 such that the door knob 110 is substantially visible and/or the handle portion 114 is unrestricted by the door knob 110 and is readily accessible to an end-user.

With further reference to FIGS. 2B and 2C, the adapter 100 may optionally include an appearance cap or shell 126 that is configured to fit over and to cover the screw band 118, e.g., after assembly and attachment of the lever handle 112 to a supporting shaft, stalk or rotation axis of the door knob 110, to help to provide an aesthetically-pleasing and/or finished appearance of the adapter 100.

The lever handle 112 may be constructed of one or more materials suitable to provide sufficient strength to the adapter 100 and to help to transfer sufficient force or torque to a door latch mechanism to release or to otherwise actuate such mechanism. Such one or more materials include, but are not limited to, metal, metal alloy, plastic, ABS plastic, rubber, synthetic rubber, elastomeric material, wood, and any combinations thereof. Further, the lever handle 112, and/or the split collar clamp 116 may be constructed by any of various manufacturing processes or techniques including, but not limited to, die cast molding processes, injection molding processes, and any combinations thereof.

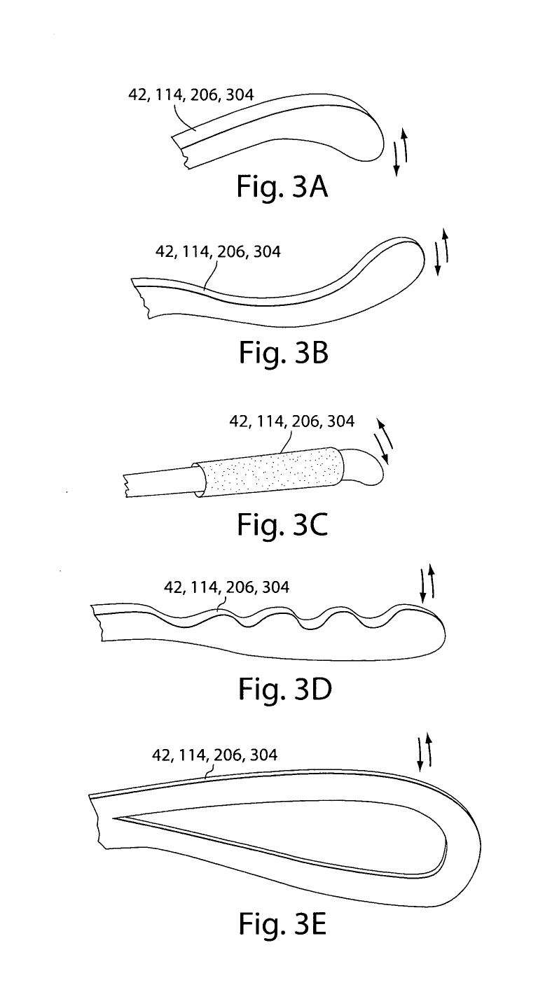

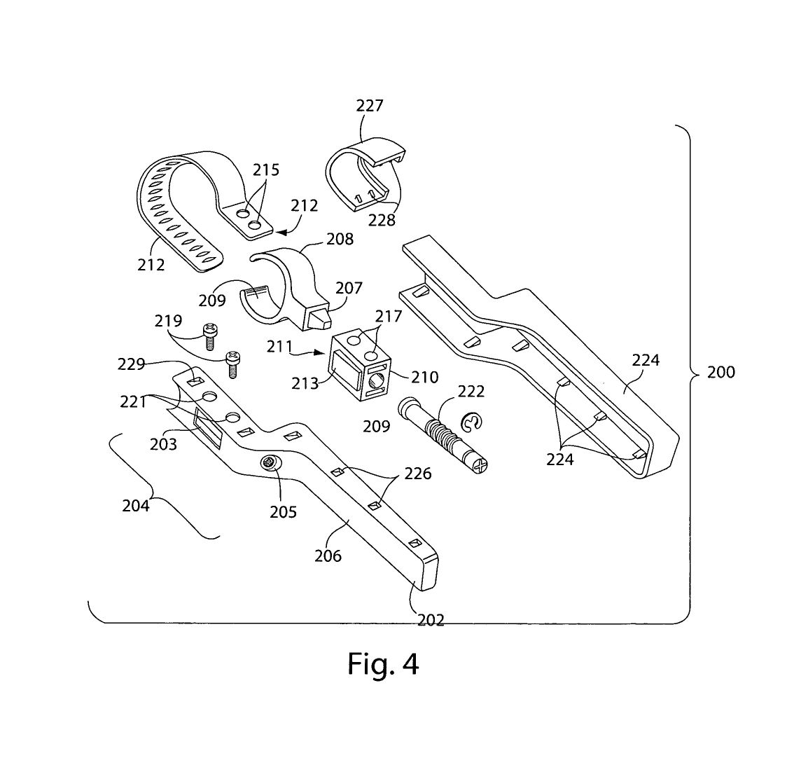

Referring to FIGS. 3A-3E, exemplary configurations of the handle portion 44 of the lever handle 12 shown in FIG. 1, the handle portion 114 of the lever handle 112 shown in FIGS. 2A-2C, as well as handle portions 206, 304, and 404A-404B of adapters 200, 300 and 400, respectively, as shown in and described below with reference to FIGS. 4-6C, are possible to fit to or to otherwise accommodate various sizes of human hands. FIGS. 3A and 3B illustrate the handle portion 44, 114, 206 and 304 can define an upward-turned arc or a downward-turned arc to accommodate a human hand and to help to capture, for instance, an upward or a downward movement or pulling force applied by an end-user's hand. In addition, FIG. 3C illustrates the handle portion 44, 114, 206, and 304 can further include a padded, cushioned or other frictional surface that helps to minimize hand slippage and helps to increase comfort to an end-user during actuation of the lever handle 12, 112, 202 and 302. Further, FIGS. 3D and 3E illustrate the handle portion 44, 114, 206, and 304 can define certain shapes such as, for instance, one or more finger indents to accommodate one or more of an end-user's fingers and a loop that allows an end-user to place their hand, fingers or another apparatus inside the loop to help to actuate the lever handle 12, 112, 202 and 302. The handle portion 44, 114, 206 and 304 or the lever handle 12, 112, 202 and 302 can be constructed of a variety of materials including, but not limited to, metal, metal alloy, plastic, ABS plastic, rubber, synthetic, rubber, elastomeric material, wood, and any combination thereof. In view of the present disclosure, those of ordinary skill in the art will appreciate and envision other possible variations and configurations of the handle portion 44, 114, 206 and 304 and the lever handle 12, 112, 202 and 302.

Referring to FIG. 4, in another aspect, the invention provides a door knob adapter 200 including a lever handle 202 having a base plate 204 and a handle portion 206, a split collar clamp 208, a clamp housing 210, and a tightening band 212. The split collar clamp 208 is shaped and is sized to surround a supporting shaft, stalk or rotation axis of a door knob (not shown) to attach to such door knob supporting shaft, stalk or rotation axis to facilitate connection of the lever handle 202.

At least a portion of an inner surface 209 of the split collar clamp 208 can include a surface that engages with a surface of a door knob supporting shaft, stalk or rotation axis with a relatively high coefficient of friction to enable the inner surface 209 to serve as a gripping surface that helps to achieve a non-slip fit and attachment of the split collar clamp 208 and the lever handle 202 to the supporting shaft, stalk or rotation axis. Such a gripping surface of the split collar clamp 208 can be accomplished by applying a material, a coating or other treatment to at least a portion of the inner surface 209 to help to promote friction between the inner surface 209 and a surface of the door knob supporting shaft, stalk or rotation axis. In one instance, the material can include one or more materials suitable for creating a gripping surface, including, but not limited to, elastomeric material, rubber, synthetic rubber, adhesive, high friction chemical application, and any combinations thereof. In addition, in another instance, the split collar clamp 208 itself can be wholly or partially constructed of one or more of such materials to enable the inner surface 209 to serve as a gripping surface as described. Alternatively, or additionally, the inner surface 209 can define a textured, scored, knurled, brushed, pitted or other treated surface configured to help to provide a gripping surface and to promote friction between the inner surface 209 and a surface of a door knob supporting shaft, stalk or rotation axis. Optionally, a material, a coating or other treatment can be applied to a surface of a door knob supporting shaft, stalk or rotation axis to help to increase the friction between the inner surface 209 and the surface of the supporting shaft, stalk or rotation axis. The non-slip fit and attachment of the split collar clamp 208 to a door knob supporting shaft, stalk or rotation axis helps to enable the rotation or otherwise the actuation of the supporting shaft, stalk or rotation axis of a door knob using the lever handle 202 when the adapter 200 is assembled and connected to the supporting shaft, stalk or rotation axis.

The adapter 200 is attached to the supporting shaft, stalk or rotation axis of a door knob such that the handle portion 206 extends transversely from an axis of the split collar clamp 208. The frictionally attached split collar clamp 208, secured by the screw band 212 as described below, causes the adapter 200 and, more specifically, the handle portion 206 to have a fixed positive relation to a door knob supporting shaft, stalk or rotation axis to allow the shaft, stalk or rotation axis to rotate or to otherwise actuate as a result of an end-user applying force or torque to the handle portion 206, e.g., by pushing the handle portion 206 in a downward or an upward movement. A latch mechanism associated with the door knob shaft, stalk or rotation axis is thereby actuated or released without undue effort.

A portion or an end 207 of the split collar clamp 208 is configured such that at least part of the portion or end 207 engages with a complementary fastening feature 211 of the clamp housing 210 to connect the clamp 208 to the housing 210. As shown in FIG. 4, the portion or end of the clamp 208 may be configured with a plug 207. At least a portion of the plug 207 is received by a complementary fastening indenture or depression 211 defined in the clamp housing 210 whereby at least a portion of the plug 207 fits securely within the indenture or depression 211 to thereby connect the clamp 208 to the housing 210. The invention is not limited to the plug 207 and the indenture or depression 211 of the clamp 208 and housing 210, respectively, and envisions any of a variety of complementary features of the clamp 208 and the housing 210 that would provide a fastening and/or locking combination. Those of ordinary skill in the art will appreciate the possible alternate configurations of the portion or end 207 of the clamp 208 and the complementary fastening feature 211 that would achieve a connection between the clamp 208 and the clamp housing 210.

The clamp housing 210 further includes a configuration 213, e.g., defined along an exterior surface, that is sized and is shaped to mate with or to otherwise engage a complementary fastening feature 203 defined in the lever handle 202 to enable the clamp housing 210 to attach to the lever handle 202. As shown in FIG. 4, the configuration may include a raised flange 213 defined along an exterior surface of the housing 210 that is sized and shaped such that at least a portion of the flange 213 is received by an aperture or slot 203 defined in the base plate 204 of the lever handle 202 whereby such portion of the flange 213 fits securely therein. The invention is not limited in this respect and anticipates any of a variety of configurations 213 and complementary fastening features 211 of the clamp housing 210 and lever handle 202, respectively, that would provide a fastening and/or locking combination. Those of ordinary skill in the art will appreciate the possible alternative configurations of the configuration 213 and the complementary fastening feature 203 that would achieve a connection between the clamp housing 210 and the base plate 204 of the lever handle 202.

Alternatively, the clamp housing 210 and the lever handle 202 may be integral and contiguous to define a single component of the adapter 200, wherein the clamp housing 210 is formed with or is otherwise defined by the base plate 204 and/or the lever handle 202. One or more bores 217 and 221 of the clamp housing 210 and the base plate 221, as shown in FIG. 4 and as described below, in this case would be defined through the lever handle 202.

The tightening band 212 includes a metal or plastic screw band that is configured along one end 212A to connect to the clamp housing 210. As shown in FIG. 4, one or more bores 215 are defined along the one end 212A of the screw band 212 that are disposed and are configured to substantially align with one or more bores 217 defined in the clamp housing 210 such that the screw band 212 is connected to the clamp housing 210 by one or more screws 219. In addition, the screw band 212 is connected to the clamp housing 210 when the clamp housing 210 is connected to the base plate 204 of the lever handle 202. The lever handle 202 defines one or more bores 221 along the base plate 204 such that when the clamp housing 210 is connected to the lever handle 202, as described above, the bores 217 of the clamp housing 210 substantially align with the bores 221 of the base plate 204. The bores 215 along the one end 212A of the screw band 212 may substantially align with the bores 217 and 221 of the clamp housing 210 and base plate 204, respectively, to permit connection of the screw band 212 to the clamp housing 208 and to the base plate 204 with the one or more screws 219.

The screw band 212 is shaped and is sized, e.g., defines a width and a length, that permits the screw band 212 to substantially encircle and to clamp around the slit collar clamp 208 where the clamp 208 is attached to a supporting shaft, stalk or rotation axis of a door knob. The clamp housing 210 is adapted to receive at least a portion of the screw band 212 where at least a portion of the screw band 212 is fed into the housing 210. Residing within the clamp housing 210 is a tightening screw 222. Where the portion of the screw band 212 fed into the clamp housing 210 engages with the tightening screw 222, the tightening screw 222 is actuated or rotated to tighten or otherwise adjust the screw band 212 about the slit collar clamp 208 to thereby clamp the screw band 212 around the slit collar clamp 208. The tightening screw 222 is configured and is disposed in the clamp housing 210 to permit access to and to enable tightening of the screw 222 from an area external to the lever handle 202 and the clamp housing 210. The lever handle 202 further defines a bore 205 that permits insertion of the tightening screw 222 through the bore 205 and into a bore 209 of the clamp housing 210 where the clamp housing 210 is attached to the base plate 204 to connect the tightening screw 222 with the clamp housing 210. In addition, the bore 205 helps to dispose the tightening screw 222 to facilitate access to the tightening screw 222 for tightening or otherwise adjustment of the screw band 212, as described. As shown in FIG. 4, where the clamp housing 210 is connected or not connected to the base plate 204, the tightening screw 222 may be accessed with a screwdriver during assembly of the adapter 200 to a door knob supporting shaft, stalk or rotation axis.

The adapter 200 may optionally include an appearance cap or shell 224 configured to mate with and to otherwise fit onto the lever handle 202 to provide the adapter 200 with an aesthetically-pleasing and/or finished appearance when the adapter 200 is attached to a door knob supporting shaft, stalk or rotation axis. The appearance cap or shell 224 can include a plurality of fastening features 225 that are configured to engage with a plurality of complementary locking features 226 of the lever handle 202 such that engagement of at least one fastening feature 225 with a complementary locking feature 226 helps to connect the appearance cap or shell 224 with the lever handle 202. As shown in FIG. 4, the plurality of fastening features can include multiple protrusions 225 and the plurality of complementary locking features can include multiple indentures or slots 226, each of which are configured to receive at least a portion of a protrusion 225 to help to connect the appearance cap or shell 224 with the lever handle 202. The protrusions 225 and the complementary indentures or slots 226 essentially define a snap-fit mount and locking combination that easily connects and removes the appearance cap or shell 224 to/from the lever handle 202. The invention is not limited with respect to the plurality of fastening features 225 and complementary locking features 226 of the appearance cap or shell 224 and the lever handle 202, respectively, and envisions any of a variety of configurations of fastening and locking features 225 and 226 to create a locking combination whereby the appearance cap or shell 224 is attached to the lever handle 202.

Similarly, the adapter 200 may optionally include a clamp appearance cap or shell 227 that fits over the screw band 212 and connects to the lever handle 202 when the adapter 200 is assembled and connected to a door knob supporting shaft, stalk or rotation axis. The clamp appearance cap or shell 227 provides an aesthetically-pleasing and/or finished appearance of the adapter 200. The appearance cap or shell 227 can include a plurality of fastening features 228 that are configured to engage with a plurality of complementary locking features 229 of the lever handle 202 such that engagement of at least one fastening feature 228 with a complementary locking feature 229 helps to connect the clamp appearance cap or shell 227 over the screw band 212 and to the lever handle 202. As shown in FIG. 4, the plurality of fastening features can include multiple protrusions 228 and the plurality of complementary locking features can include multiple indentures or slots 229, each of which are configured to receive at least a portion of a protrusion 228 to help to connect the clamp appearance cap or shell 227 over the screw band 212 and to the lever handle 202. The protrusions 228 and the complementary indentures or slots 229 essentially define a snap-fit mount and locking combination that easily connects and removes the clamp appearance cap or shell 228 to/from the lever handle 202. The invention is not limited with respect to the plurality of fastening features 228 and complementary locking features 229 of the clamp appearance cap or shell 227 and the lever handle 202, respectively, and envisions any of a variety of configurations of fastening and locking features 228 and 229 to create a locking combination whereby the clamp appearance cap or shell 227 is attached over the screw band 212 and to the lever handle 202. Alternatively, the appearance cap or shell 227 may be connected to or integral with the appearance cap or shell 224 for the lever handle 202.

The appearance cap or shell 224 and 227 may be constructed or otherwise have a finish or an exterior that helps to enhance the appearance of the adapter 200 when attached to a door knob shaft, stalk or rotation axis, and/or that helps the appearance of the adapter 200 blend with or otherwise complement the existing appearance and/or décor of the door and/or the room in which the door is located. The appearance cap or shell 224 and 227 may be designed with various aesthetic schemes for such enhancement. For instance, the appearance cap or shell 224 and 227 may be any of a variety of colors, patterns, designs, or finishes. In addition, in another instance, the appearance cap or shell 224 and 227 may be fitted with a skin or a shell of any of a variety of colors, patterns, designs, or finishes. Such skin or shell may be removable such that an end-user may select a skin or shell from a variety of designs for application to the appearance cap or shell 224 and 227, and/or may easily change the skin or shell of the adapter 200 by simply removing one skin or shell and replacing it with another.

The lever handle 202 may be constructed of one or more materials suitable to provide sufficient strength to the adapter 200 and to help to transfer sufficient force or torque to a door latch mechanism to actuate or to otherwise release such mechanism. Such one or more materials include, but are not limited to, metal, metal alloy, plastic, ABS plastic, rubber, synthetic rubber, elastomeric material, wood, and any combinations thereof. Further, the lever handle 202, the clamp housing 210, and/or the split collar clamp 208 may be formed by any of various manufacturing processes or techniques including, but not limited to, die cast molding processes, injection molding processes and any combinations thereof.

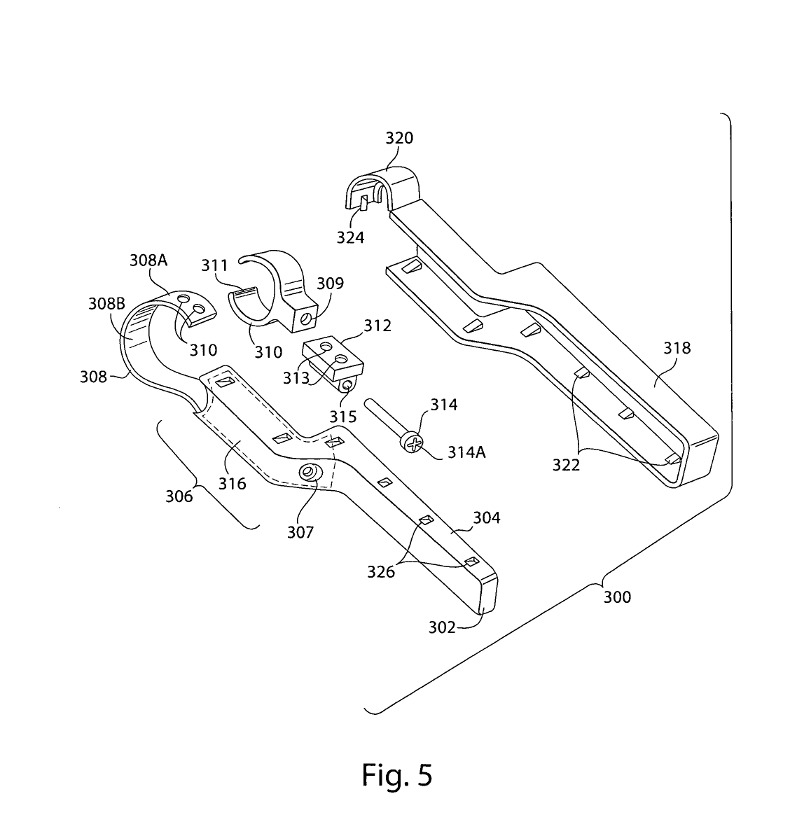

Referring to FIG. 5, in a further aspect, the invention provides a door knob adapter 300 including a lever handle 302 having a handle portion 304 and a base plate 306, a split collar clamp 310, a sliding clamp block 312, and a tightening band 308. The split collar clamp 310 is shaped and is sized to surround a supporting shaft, stalk or rotation axis of a door knob (not shown) to attach the lever handle 302 to such door knob shaft, stalk or rotation axis. The tightening band 308 can include a metal or plastic screw band and is shaped and is sized, e.g., defines a width and a length, that permits the screw band 308 to substantially encircle and to clamp around the split collar clamp 310 where the clamp 310 is attached to a door knob supporting shaft, stalk or rotation axis.

At least a portion of an inner surface 311 of the split collar clamp 310 can include a surface that engages with a surface of a door knob supporting shaft, stalk or rotation axis with a relatively high coefficient of friction to enable the inner surface 311 to serve as a gripping surface that helps to achieve a non-slip fit and attachment of the split collar clamp 310 and the lever handle 302 to the supporting shaft, stalk or rotation axis. Such a gripping surface of the split collar clamp 310 can be accomplished by applying a material, a coating or another treatment to at least a portion of the inner surface 209 to help to promote friction between the inner surface 311 and a surface of the door knob supporting shaft, stalk or rotation axis. In one instance, the material can include one or more materials suitable for creating a gripping surface, including, but not limited to, elastomeric material, rubber, synthetic rubber, adhesive, high friction chemical application, and any combinations thereof. In addition, in another instance, the split collar clamp 310 itself can be wholly or partially constructed of one or more of such materials to enable the inner surface 311 to serve as a gripping surface that provides friction with a surface of a door knob supporting shaft, stalk or rotation axis. Alternatively, or additionally, the inner surface 311 can define a textured, scored, knurled, brushed, pitted or other treated surface configured to help to provide a gripping surface and to promote friction between the inner surface 311 and a surface of a door knob supporting shaft, stalk or rotation axis. Optionally, a material, a coating or another treatment can be applied to a surface of a door knob supporting shaft, stalk or rotation axis to help to increase the friction between the inner surface 311 and the surface of the supporting shaft, stalk or rotation axis. The non-slip fit and attachment of the split collar clamp 310 to a door knob supporting shaft, stalk or rotation axis helps to enable the rotation or otherwise the actuation of the supporting shaft, stalk or rotation axis using the lever handle 302 when the adapter 300 is assembled and connected to the supporting shaft, stalk or rotation axis.

The adapter 300 is attached to the supporting shaft, stalk or rotation axis of a door knob such that the handle portion 304 extends transversely from an axis of the split collar clamp 310. The frictionally attached split collar clamp 310, secured to the shaft, stalk or rotation axis by the screw band 308 as described below, causes the adapter 300 and, more specifically, the lever handle 302 to have a fixed positive relation to the shaft, stalk or rotation axis to allow the shaft, stalk or rotation axis to rotate or to otherwise actuate as a result of an end-user applying force or torque to the handle portion 304, e.g., by pushing the handle portion 304 in a downward or an upward movement. A latch mechanism associated with the door knob shaft, stalk or rotation axis is thereby released or otherwise actuated without undue effort by the end-user.

As shown in FIG. 5, the split collar clamp 310 defines along one end a bore 309 disposed and configured to substantially align with a bore 315 defined through the sliding clamp block 312 and to receive at least a portion of a tightening screw 314. The block bore 315 extends a length of the sliding clamp block 312 from one end to another opposing end such that the bore 315 is defined through the sliding clamp block 312. The clamp 310 is attached to the sliding clamp block 312 by substantially aligning the clamp bore 309 with the block bore 315 and inserting the tightening screw 314 through the block bore 315 such that at least a portion of the screw 314 is received by the clamp bore 309. The tightening screw 314 includes a tightening or actuation feature 314A that permits an end-user to actuate the screw 314 to tighten or otherwise adjust the screw 314 in the respective bores 309 and 315.

The base plate 306 of the lever handle 302 defines within its interior an indenture or a depression 316 configured to receive at least a portion of the sliding clamp block 312 to engage the block 312 with the base plate 306. As shown in FIG. 5, where at least a portion of the sliding clamp block 312 is received by the indenture or depression 316 of the base plate 306, the bore 315 of the sliding clamp block 312 substantially aligns with a bore 307 defined in the base plate 306. The tightening screw 314 is received by the base plate bore 307 and thereafter by the block bore 315 and the clamp bore 309. The tightening screw 314 is tightened or actuated via the tightening feature 314A to connect the clamp 310 and the sliding clamp block 312 together, as described above, and to further connect the clamp 310 and the sliding clamp block 312 to the base plate 306. When assembled with the base plate 306, the sliding clamp block 312, and the clamp 310, the tightening screw 314 is accessible from an area external to the base plate 306 to permit tightening or actuating of the screw 314.

The screw band 308 is adapted along one end 308A to connect to and to detach from the sliding clamp block 312 and, more specifically, to connect to and to detach from the sliding clamp block 312 when the split collar clamp 310 is attached to the block 312. In one instance, the one end 308A of the screw band 308 is constructed and arranged to connect to and to detach from one or more mating/fastening features 312, e.g., headed pins, tabs, screws, strong magnets, latches or cam locks, of the sliding clamp block 312. In one instance, the one end 308A of the screw band 308 defines one or more bores 317 with each bore 317 disposed and configured to substantially align with a corresponding mating/fastening feature 313 defined along the sliding clamp block 312 such that the bore 317 engages at least a portion of the mating/fastening feature 313 to enable removable connection of the one end 308A of the screw band 308 to the sliding clamp block 312. The invention is not limited in this respect and anticipates any of a variety of configurations along the one end 308A of the screw band 308 and any of a variety of complementary mating/fastening features 313 along the sliding clamp block 312 to effect connection of the screw band 308 with the block 312. Those of ordinary skill in the art will appreciate the possible alternative configurations and complementary mating/fastening features that would achieve such connection.

As mentioned, the screw band 308 is shaped and is sized to permit the screw band 308 to substantially encircle and to clamp around the split collar clamp 310. Where the clamp 310 is disposed around or attached to a door knob supporting shaft, stalk or rotation axis, the screw band 308 has sufficient length to encircle the clamp and to permit connection to the sliding clamp block 312 as described above.

At least a portion of an inner surface 308B of the screw band 308 can include a surface that engages with a surface of the split collar clamp 310 with a relatively high coefficient of friction to enable the inner surface 308A to serve as a gripping surface that helps to achieve non-slip mating of the screw band 308 with the split collar clamp 310. Such a gripping surface of the screw band 308 can be accomplished by applying a material, a coating or another treatment to at least a portion of the inner surface 308B to help to promote friction between the inner surface 308B and the surface of the clamp 310. In one instance, the material can include one or more materials suitable for creating a gripping surface, including, but not limited to, an elastomeric material, e.g., a low durometer elastomer, rubber, synthetic rubber, adhesive, high friction chemical application, and any combinations thereof. In addition, in another instance, the screw band 308 itself can be wholly or partially constructed of one or more of such materials to enable the inner surface 308B to serve as a gripping surface that provides friction with the surface of the clamp 310 to help to achieve a non-slip fit and attachment of the clamp 310 to a surface of a door knob supporting shaft, stalk or rotation axis. Alternatively, or additionally, the inner surface 308B can define a textured, scored, knurled, brushed, pitted or other treated surface configured to help to provide a gripping surface and to promote friction between the inner surface 308B and the surface of the clamp 310.

The adapter 300 may optionally include an appearance cap or shell 318 configured to mate with and to otherwise fit to the lever handle 302 to provide the adapter 300 with an aesthetically-pleasing and/or finished appearance when the adapter 300 is attached to a door knob supporting shaft, stalk or rotation axis. The appearance cap or shell 318 can include a plurality of fastening features 322 that are configured to engage with a plurality of complementary locking features 326 of the lever handle 302 such that engagement of at least one fastening feature 322 with a complementary locking feature 326 helps to connect the appearance cap or shell 318 with the lever handle 302. As shown in FIG. 5, the plurality of fastening features can include multiple protrusions 322 and the plurality of complementary locking features can include multiple indentures or slots 326, each of which are configured to receive at least a portion of a protrusion 322 to help to connect the appearance cap or shell 318 with the lever handle 302. The protrusions 322 and the complementary indentures or slots 326 essentially define a snap-fit mount and locking combination that easily connects and removes the appearance cap or shell 318 to/from the lever handle 302. The invention is not limited with respect to the plurality of fastening features 322 and complementary locking features 326 of the appearance cap or shell 318 and the lever handle 302, respectively, and envisions any of a variety of configurations of fastening and locking features 322 and 326 to create a locking combination whereby the appearance cap or shell 318 is attached to the lever handle 302.

Similarly, the adapter 300 may optionally include a clamp appearance cap or shell 320 that fits over the screw band 308 where the screw band 308 is clamped around the clamp 310. The appearance cap or shell 320 may connect to the lever handle 302 when the adapter 300 is assembled and connected to a door knob supporting shaft, stalk or rotation axis. The clamp appearance cap or shell 320 helps to provide an aesthetically-pleasing and/or finished appearance of the adapter 300. The appearance cap or shell 320 can include one or more fastening features 324 that are configured to engage with any one of the plurality of complementary locking features 326 along the lever handle 302 such that engagement of at least one fastening feature 324 with a complementary locking feature 326 helps to connect the clamp appearance cap or shell 324 over the screw band 308 and to the lever handle 302. As shown in FIG. 5, the one or more fastening features can include one or more protrusions 324 and the plurality of complementary locking features, as described above, can include multiple indentures or slots 326, each of which are configured to receive at least a portion of a protrusion 324 to help to connect the clamp appearance cap or shell 320 over the screw band 308 and to the lever handle 302. The protrusions 324 and the complementary indentures or slots 326 essentially define a snap-fit mount and locking combination that easily connects and removes the clamp appearance cap or shell 320 to/from the lever handle 302. The invention is not limited with respect to the one or more fastening features 324 and complementary locking features 326 of the clamp appearance cap or shell 320 and the lever handle 302, respectively, and envisions any of a variety of configurations of fastening and locking features 324 and 326 to create a locking combination whereby the clamp appearance cap or shell 320 is attached over the screw band 308 and to the lever handle 302. Alternatively, or additionally, the clamp appearance cap or shell 320 may be connected to the appearance cap or shell 318 of the lever handle 302.

The appearance cap or shell 318 and 320 may be constructed or otherwise have a finish or an exterior that helps to enhance the appearance of the adapter 300 when attached to a door knob shaft, stalk or rotation axis, and/or that helps the appearance of the adapter 300 blend with or otherwise complement the existing appearance and/or décor of the door and/or the room in which the door is located. The appearance cap or shell 318 and 320 may be designed with various aesthetic schemes for such enhancement. For instance, the appearance cap or shell 318 and 320 may be any of a variety of colors, patterns, designs, or finishes. In addition, in another instance, the appearance cap or shell 318 and 320 may be fitted with a skin or a shell of any of a variety of colors, patterns, designs, or finishes. Such skin or shell may be removable such that an end-user may select a skin or shell from a variety of designs for application to the appearance cap or shell 318 and 320, and/or may easily change the skin or shell of the adapter 300 by simply removing one skin or shell and replacing it with another.

The lever handle 302 may be wholly or partially constructed of one or more materials suitable to provide sufficient strength to the adapter 300 and to help to transfer sufficient force or torque to a door latch mechanism to actuate or to otherwise release such mechanism. Such one or more materials include, but are not limited to, metal, metal alloy, plastic, ABS plastic, rubber, synthetic rubber, elastomeric material, wood, and any combinations thereof. Further, the lever handle 302, the sliding clamp block 312, and/or the split collar clamp 310 may be formed by any of various manufacturing processes or techniques including, but not limited to, die cast molding processes, injection molding processes and any combinations thereof.

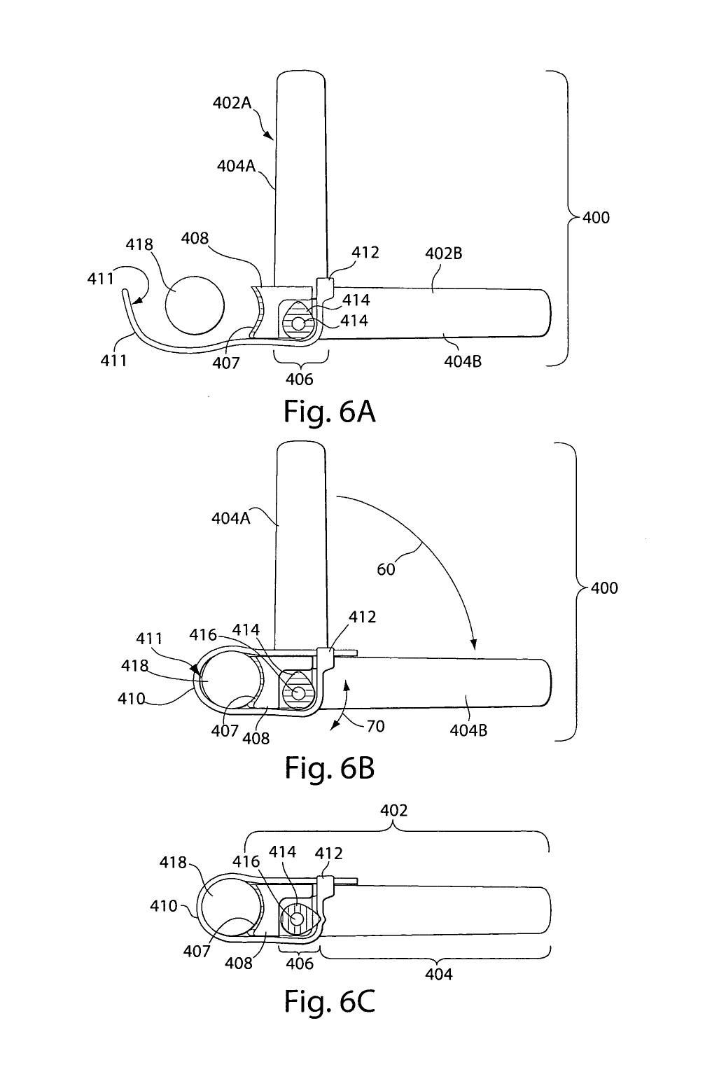

Referring to FIG. 6, in another aspect, the invention provides a door knob adapter 400 including a split lever handle 402 having a first lever 402A and a second lever 402B. Each lever 402A and 402B includes a handle portion 404A and 404B. The split lever handle 402 further includes a base plate 406, a collar clamp 408, and a tightening band 410. The collar clamp 408 is sized and is shaped to engage and to mate with as least a portion of a supporting shaft, stalk or rotation axis 418 of a door knob (not shown) to help to engage the lever handle 402 to the shaft, stalk or rotation axis 418. The tightening band 410 includes a metal or plastic band that is sized and is shaped, e.g., defines a width and a length, that permits at least a portion of the band 410 to substantially encircle the shaft, stalk or rotation axis 418 and the collar clamp 408 when the collar clamp 408 is mated with at least a portion of the shaft, stalk or rotation axis 418 and to clamp around the shaft, stalk or rotation axis 418 and the collar clamp 408 to help to secure the lever handle 402 to the shaft, stalk or rotation axis 418, as shown in FIG. 6C.

At least a portion of an inner surface 407 of the collar clamp 408 can include a surface that engages with a surface of the door knob supporting shaft, stalk or rotation axis 418 with a relatively high coefficient of friction to enable the inner surface 407 to serve as a gripping surface that helps to achieve non-slip mating of the collar clamp 408 to the shaft, stalk or rotation axis 418. In addition, when the tightening band 410 is clamped around the shaft, stalk or rotation axis 418 and the collar clamp 408, the inner surface 407 of the collar clamp 408 along with the band 410 help to achieve a non-slip fit and attachment of the lever handle 402 and the adapter 400 to the supporting shaft, stalk or rotation axis 418. Such a gripping surface can be accomplished by applying a material, a coating or other treatment to at least a portion of the inner surface 407 to help to promote friction between the inner surface 407 and a surface of the door knob supporting shaft, stalk or rotation axis 418. In one instance, the material can include one or more materials suitable for creating a gripping surface, including, but not limited to, elastomeric material, rubber, synthetic rubber, adhesive, high friction chemical application, and any combinations thereof. In addition, in another instance, the collar clamp 408 itself can be wholly or partially constructed of one or more of such materials to enable the inner surface 407 to serve as a gripping surface that provides friction with a surface of the door knob supporting shaft, stalk or rotation axis 418. Alternatively, or additionally, the inner surface 407 can define a textured, scored, knurled, brushed, pitted or other treated surface configured to help to provide a gripping surface and to promote friction between the inner surface 407 and a surface of a door knob supporting shaft, stalk or rotation axis 418. Optionally, a material, a coating or other treatment can be applied to a surface of the shaft, stalk or rotation axis 418 to help to increase the friction between the inner surface 407 of the clamp 408 and the surface of the supporting shaft, stalk or rotation axis 418. The non-slip mating of the collar clamp 408 and the tightening of the band 408 around the door knob supporting shaft, stalk or rotation axis 418 and the clamp 408 help to enable the rotation or otherwise the actuation of the shaft, stalk or rotation axis 418 using the lever handle 402 when the adapter 400 is assembled and connected to the supporting shaft, stalk or rotation axis 418.

The adapter 400 is attached to the supporting shaft, stalk or rotation axis 418 of a door knob such that the lever handle 404 extends transversely from an axis of the collar clamp 408. When the tightening band 410 is engaged with and tightened around the shaft, stalk or rotation axis 418 and the collar clamp 408, as described in further detail below, the band 410 and the frictionally-mated collar clamp 310 help to cause the lever handle 404 to have a fixed positive relation to the shaft, stalk or rotation axis 418 to allow the shaft, stalk or rotation axis 418 to rotate or to otherwise actuate as a result of an end-user applying force or torque to the lever handle 404, e.g., by pushing the lever handle 404 in a downward or an upward movement. A latch mechanism associated with the door knob shaft, stalk or rotation axis 418 is thereby released or otherwise actuated without undue effort by the end-user.

As shown in FIGS. 6A-6C, the lever handle 402 includes a base plate 406 to which the collar clamp 408 is attached to or is integral with. A pivoting cam 414 resides within or along the base plate 406. The pivoting cam 414 includes a pivot 416 and is constructed and arranged to engage with and to connect the pivot 416 to an end of each of the first and second levers 402A and 402B to thereby attach the levers 402A and 402B to the base plate 406 of the lever handle 402. The pivot 416 facilitates pivoting or rotation of at least one of the first and second levers 402A and 402B about the pivot 416. More specifically, in one instance, the pivot 416 facilitates pivoting or rotating of the first lever 404A about the pivot 416, e.g., in a downward or an upward orientation as shown by arrow 60 in FIG. 6B, to move the first lever 404A from a first or an unlocked position, as shown, for example, in FIGS. 6A and 6B, to a second or locked position, as shown, for example, in FIG. 6C. When the first lever 404A is disposed in the second or locked position, the first and second levers 402A and 402B are substantially parallel to one another. As described in further detail below, movement or pivoting of the first lever 402A in a downward or an upward orientation, as shown by arrow 60 in FIG. 6B, causes the cam 414 to rotate or to otherwise actuate in a downward or an upward orientation or vice versa, as shown by arrow 70 in FIG. 6B, to dispose the cam 414 in a first or unlocked position, as shown in FIGS. 6A and 6B, or in a second or locked position, as shown in FIG. 6C. In another instance, the cam 414 can pivot simultaneously with the movement of at least one of the first and second levers 402A and 402B, as shown by arrow 60 in FIG. 6B, to move the cam 414 from the first or unlocked position, as shown in FIGS. 6A and 6B, to the second or locked position, as shown in FIG. 6C. Where the cam 414 is disposed in the second or locked position, the cam 414 helps to further tighten the tightening band 410 about the door knob shaft, stalk or rotation axis 418 and the collar clamp 408.

The tightening band 410, as mentioned, is sized and is shaped to permit the band 410 to substantially encircle and to clamp around the door knob shaft, stalk or rotation axis 418 and the collar clamp 408 when the clamp 408 is mated with the shaft, stalk or rotation axis 418. At least a portion of the tightening band 410 is received by a locking tab 412 that is disposed along the base plate 406 opposite to a site from which the tightening band 410 extends from the base plate 406 and/or the lever handle 402. The locking tab 412 is constructed and arranged to engage with and to lock to the received portion of the tightening band 410 to secure the tightening band 410 therewith. In addition, the locking tab 412 is adapted to provide a point of insertion of the portion of the tightening band 410 and an exit point such that the portion of the tightening band 410 may exit from the locking tab 412, as shown in FIG. 6C. The tightening band 410 is adapted such that at least the portion of the tightening band 410 received by the locking tab 412 is securely engaged with or otherwise connected to at least a portion of the locking tab 412. Further, the locking tab 412 is disposed at a location along the base plate 406 and/or the lever handle 402 such that the locking tab 412 serves as a point at which the tightening band 410 may be tightened or otherwise adjusted about the shaft, stalk or rotation axis 418 of a door knob.

The tightening band 410 can include a metal or plastic serrated band 410 of which at least a portion includes one or more serrated edges. The locking tab 412 can be adapted to receive the portion of the band 410 having the one or more serrated edges and to mate with or otherwise engage the portion of the band 410 and/or the one or more serrated edges to lock the band 410 with the locking tab 412. The locking tab 412 can be further adapted to removably lock the band 410 with the locking tab 412 as described.

As shown in FIGS. 6B and 6C, when the portion of the band 410 is received by the locking tab 412 through the point of insertion, the locking tab 412 is adapted to permit the portion of the band 410 to extend through the body of the locking tab 410 and to exit from the exit point of the locking tab 412. The portion of the band 410 exiting from the locking tab 412 may be pulled further through the locking tab 412 to thereby tighten or otherwise adjust the band 410 about the shaft, stalk or rotation axis 418 to help to achieve a non-slip fit and attachment of the lever handle 402 and the adapter 400 to the shaft, stalk or rotation axis 418. The band 410 and/or the locking tab 412 may be further adapted such that the band 410 is removable from the locking tab 412 to permit removal and reentry of the portion of the band 410 from/into the locking tab 412. As shown in FIGS. 6A-6C, in one configuration, the tightening band 410 is integral with the locking tab 412 along one of its ends such that the band 410 is contiguous with the locking tab 412.

The tightening band 410 is disposed with or attached to the base plate 406 and in proximity to the cam 414 such that when the cam 414 is engaged and is disposed in the second or locking position, as shown in FIG. 6C, the cam 414 engages or mates with, e.g., applies force to, the band 410 to help to further tighten and/or to help to secure the band 410 about the door knob shaft, stalk or rotation axis 418 such that the lever handle 402 achieves a non-slip fit and attachment to the shaft, stalk or rotation axis 418.

At least a portion of an inner surface 411 of the tightening band 410 can include a surface that engages with a surface of the door knob shaft, stalk or rotation axis 418 with a relatively high coefficient of friction to enable the inner surface 411 to serve as a gripping surface that helps to achieve non-slip mating of the band 410 with a surface of the shaft, stalk or rotation axis 418. Such a gripping surface of the band 410 can be accomplished by applying a material, a coating or other treatment to at least a portion of the inner surface 411 to help to promote friction between the inner surface 411 and the surface of the shaft, stalk or rotation axis 418. In one instance, the material can include one or more materials suitable for creating a gripping surface, including, but not limited to, an elastomeric material, rubber, synthetic rubber, adhesive, high friction chemical application, and any combinations thereof. In addition, in another instance, the band 410 itself can be wholly or partially constructed of one or more of such materials to enable the inner surface 411 to serve as a gripping surface that provides friction with the surface of the shaft, stalk or rotation axis 418 to help to achieve a non-slip fit and attachment of the lever handle 402 to the shaft, stalk or rotation axis 418. Alternatively, or additionally, the inner surface 411 can define a textured, scored, knurled, brushed, pitted or other treated surface configured to help to provide a gripping surface and to promote friction between the inner surface 411 and the surface of the shaft, stalk or rotation axis 418. Optionally, a material, a coating or other treatment can be applied to a surface of the shaft, stalk or rotation axis 418 to help to increase the friction between the inner surface 411 and the surface of the supporting shaft, stalk or rotation axis 418. The non-slip fit and attachment of the lever handle 402 to the door knob supporting shaft, stalk or rotation axis 418 helps to enable the rotation or otherwise the actuation of the supporting shaft, stalk or rotation axis 418 using the lever handle 402 when the adapter 400 is assembled and connected to the supporting shaft, stalk or rotation axis 418.

The adapter 400 is attached to the supporting shaft, stalk or rotation axis 418 of a door knob such that the handle portion 402 extends transversely from an axis of the collar clamp 408. When secured about the shaft, stalk or rotation axis 418, the tightening band 410 and the frictionally-mated collar clamp 408 cause the lever handle 402 and the adapter 400 to have a fixed positive relation to the shaft, stalk or rotation axis 418 to allow the shaft, stalk or rotation axis 418 to rotate or to otherwise actuate as a result of an end-user applying force or torque to the lever handle 402, e.g., moving the levers 402A and 402B in a downward or an upward movement. A latch mechanism associated with the door knob shaft, stalk or rotation axis 418 is thereby released or otherwise actuated without undue effort by the end-user With further reference to FIGS. 6A-6C, assembly of the adapter 400 to a door knob supporting shaft, stalk or rotation axis 418 is described and includes mating at least a portion of the inner surface 407 of the collar clamp 408 with a surface of the shaft, stalk or rotation axis 418. Assembly further includes extending the tightening band 410 and disposing at least a portion of the tightening band 410 substantially around the shaft, stalk or rotation axis 418 and inserting at least a portion of the tightening band 410 into a point of insertion of the locking tab 412 to thereby insert the portion of the band 410 into the locking tab 412. Assembly also includes inserting the portion of the band 410 such that at least a portion of the band 412 extends through the locking tab 412 and exits the locking tab 412 from a side of the locking tab 412 opposite to the point of insertion of the portion of the band 410 into the locking tab 412. In addition, assembly includes pulling, if necessary, the portion of the band 410 exiting the locking tab 412 to help to tighten or otherwise adjust the band 410 around the shaft, stalk or rotation axis 418. Once the band 410 is inserted in the locking tab 412, assembly includes moving or pivoting the first lever 402A of the lever handle 402 about the pivot 416 from the first or unlocked position, as shown in FIGS. 6A and 6B, to the second or unlocked position, as shown in FIG. 6C, by moving the first lever 402A in a downward orientation, as shown by arrow 60 in FIG. 6B, such that the first and the second levers 402A and 402B are substantially parallel one another. The cam 414 pivots or rotates simultaneously with movement of the first lever 402A such that the cam 414 turns in one of the two directions shown by arrow 70 in FIG. 6B. For instance, if the cam 414 pivots or rotates in a downward orientation simultaneously with and as a result of the downward movement of the first lever 40A, the cam 414 is disposed at the second or locking position, as shown in FIG. 6C. In the second or locking position, the cam 414 engages or mates with, e.g. applies force to, the band 410 to help to further tighten and/or to help to lock the band 410 about the shaft, stalk or rotation axis 418. In another instance, if the cam 414 pivots or rotates in an upward orientation simultaneously with and as a result of an upward movement of the first lever 402A, e.g., to move the first lever 402A from the second to the first position, the cam 414 is disposed at the first or unlocked position, as shown in FIGS. 6A and 6B. When the first lever 402A and the cam 414 are disposed in the second or locked position, the tightening band 410 helps to register the adapter 400 to the door knob shaft, stalk or rotation axis with a non-slit fit and attachment.

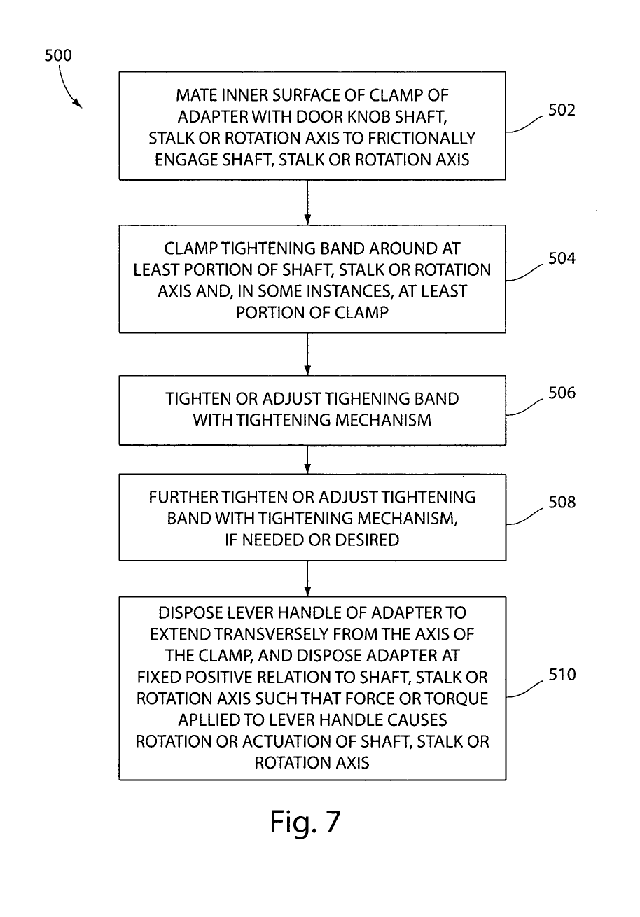

Referring to FIG. 7, and with further reference to FIGS. 1-6C, a block diagram illustrates a method 500 of adapting the door knob 110 and/or its supporting shaft, stalk or rotation axis 418 to facilitate rotation or otherwise actuation of the door knob 110 and/or its supporting shaft, stalk or rotation axis, to release or otherwise to actuate a locking mechanism associated with the door knob 110 and/or its shaft stalk or rotation axis 418, includes the stages shown. The method 500, however, is exemplary only and is not limiting. The method 500 can be altered, e.g., by having stages added, removed or rearranged.

At stage 502, an end-user mates the inner surface 117, 209, 311 and 407 of the clamp 116, 208, 310 and 408 of the adapter 100, 200, 300 and 400, respectively, with the supporting shaft, stalk or rotation axis 418 of the door knob 110. In one instance, at least a portion of the inner surface 117, 209, 311 and 407 engages a surface of the supporting shaft, stalk or rotation axis 418 with a relatively high coefficient of friction. The inner surface 117, 209, 311 and 407 may include a material, a coating or other treatment to promote friction with the surface of the supporting shaft, stalk or rotation axis 418.

At stage 504, the tightening band 118, 212, 308 and 410 of the adapter 100, 200, 300 and 400, respectively, surrounds or encircles at least a portion of the shaft, stalk or rotation axis 418 and, in some instances, at least a portion of the clamp 116, 208, 310 and 408 and clamps around the portion of the shaft, stalk or rotation axis 418 and the portion of the clamp 116, 208, 310 and 408.

At stage 506, when clamped around the portion of the shaft, stalk or rotation axis 418 and, in some instances, the portion of the clamp 116, 208, 310 and 408, a tightening mechanism 121, 210, 312 and 412 receives and engages with at least a portion of the tightening band 118, 212, 308 and 410. The tightening mechanism 121, 210, 312 and 412 is adapted to tighten or to otherwise adjust the tightening band 118, 212, 308 and 410 around the portion of the shaft, stalk or rotation axis 418 and, in some instances, the portion of the clamp 116, 208, 310 and 408 to help to achieve a non-slip fit and attachment of the adapter 100, 200, 300 and 400 to the door knob shaft, stalk or rotation axis 418.

At stage, 508, if needed or desired, further tightening and/or adjustment of the tightening band 118, 212, 308 and 410 is permitted via the tightening mechanism 121, 210 312 and 412.

At stage 510, when assembled and attached to the door knob supporting shaft, stalk or rotation axis 418, the handle portion 114, 206, 304, 404 and/or the lever handle 112, 202, 302 and 402 of the adapter 100, 200, 300 and 400 extends transversely from the axis of the clamp 116, 208, 310 and 408, and the tightening band 118, 212, 308 and 410 and/or the clamp 116, 208, 310 and 408 cause the adapter 100, 200, 300 and 400 to have a fixed position relation to the shaft, stalk or rotation axis 418 to allow the shaft, stalk or rotation axis 418 to rotate or otherwise to actuate as a result of the end-user applying a force or torque to the lever handle 112, 202, 302 and 402 which thereby releases or otherwise actuates a latch mechanism associated with the door knob 110 and/or the supporting shaft, stalk or rotation axis 418.

Having thus described at least one illustrative embodiment of the invention, various alterations, modifications and improvements will readily occur to those skilled in the art. Such alterations, modifications and improvements are intended to be within the scope and spirit of the invention. Accordingly, the foregoing description is by way of example only and is not intended as limiting. The invention's limit is defined only in the following claims and the equivalents thereto.

What is claimed is:

1. An adapter for a door knob having a supporting shaft, stalk or rotation axis, the adapter comprising:
a lever handle including a base plate and a handle portion;
a split collar clamp attached to one end of the base plate, wherein the handle portion extends transversely to the axis of the split collar clamp;
the split collar clamp adapted to frictionally engage to the supporting shaft, stalk or rotation axis;
a screw band attached to the base plate proximate to the split collar clamp such that where the split collar clamp engages the supporting shaft, stalk or rotation axis, the screw band clamps around at least a portion of the supporting shaft, stalk or rotation axis, the screw band adapted to be tightened or otherwise adjusted around the portion of the supporting shaft, stalk or rotation axis; and
a tightening screw disposed in the base plate to engage the screw band and adapted to tighten or to otherwise adjust the screw band.

2. The adapter of claim 1, wherein the split collar clamp and the screw band, when tightened or otherwise adjusted around the portion of the supporting shaft, stalk or rotation axis, cause the lever handle to have a fixed positive relation to the supporting shaft, stalk or rotation axis of the door knob.

3. The adapter of claim 1, wherein the base plate includes a clamp housing in which at least a portion of the tightening screw resides, the clamp housing adapted to permit the screw band to engage with the tightening screw.

4. The adapter of claim 3, wherein the clamp housing is an integral portion of the base plate.

5. The adapter of claim 3, wherein the clamp housing is adapted to be removably connected to at least a portion of the base plate.

6. The adapter of claim 1, wherein the tightening screw is disposed and is adapted to permit access to a tightening feature of the tightening screw from an area external to the base plate.

7. The adapter of claim 1, wherein the split collar clamp is adapted to be removably attached to the one end of the base plate.

8. The adapter of claim 7, wherein the clamp housing is adapted to be removably attached to the base plate.

9. The adapter of claim 8, wherein the screw band is adapted to be removably attached to the base plate.

10. The adapter of claim 1, wherein the screw band is adapted to be removably attached to the base plate.

11. The adapter of claim 1, wherein the screw band is permanently attached to the base plate.

12. The adapter of claim 1, wherein the split collar clamp is permanently attached to the one end of the base plate.

13. The adapter of claim 1, wherein at least a portion of an inner surface of the split collar clamp includes a material, a coating or other treatment to adapt the portion to serve as a gripping surface to promote friction between the inner surface and the supporting shaft, stalk or rotation axis of the door knob.

14. The adapter of claim 13, wherein the material includes a material selected from the group consisting of elastomeric material, rubber, synthetic rubber, adhesive, high friction chemical application, and any combinations thereof.

15. The adapter of claim 1, wherein the portion of the inner surface of the split collar clamp includes a textured, scored, knurled, brushed, pitted, or other treated surface to promote friction between the inner surface and the supporting shaft, stalk or rotation axis of the door knob.

16. The adapter of claim 1, further including an appearance cap adapted to attach to the lever handle.

17. The adapter of claim 1, further including an appearance cap adapted to attach to the slit collar clamp.

18. An adapter for a door knob having a supporting shaft, stalk or rotation axis, the adapter comprising:
a split lever handle including a base plate and a first lever and a second lever pivotally connected to the base plate by a pivoting cam such that at least the first lever pivots about a pivot of the pivoting cam;
a collar clamp disposed along one end of the base plate, wherein the split lever handle extends transversely to the axis of the collar clamp;
the collar clamp adapted to engage with the supporting shaft, stalk or rotation axis;
a tightening band attached to the base plate such that the tightening band clamps around at least a portion of the supporting shaft, stalk or rotation axis; and
a locking tab disposed along the base plate and adapted to receive at least a portion of the tightening band and to lock with the portion of the tightening band.

19. The adapter of claim 18, wherein, when tightened or otherwise adjusted around the portion of the supporting shaft, stalk or rotation axis, the tightening band and the collar clamp cause the lever handle to have a fixed positive relation to the supporting shaft, stalk or rotation axis.

20. The adapter of claim 18, wherein when the first lever pivots to a locked position and substantially parallel to the second lever, the pivoting cam pivots simultaneously to a locked position.

21. The adapter of claim 20, wherein, when in the locked position, the pivoting cam engages with the tightening band to help to tighten the tightening band about the supporting shaft, stalk or rotation axis.

22. The adapter of claim 18, wherein the tightening band is integral with the locking tab.

23. The adapter of claim 18, wherein the locking tab is adapted for removable insertion of the portion of the tightening band into the locking tab.

24. The adapter of claim 18, wherein the tightening band includes one or more serrated edges for locking with the locking tab.

25. The adapter of claim 18, wherein at least a portion of an inner surface of the collar clamp is adapted to cause the inner surface to frictionally engage with a surface of the supporting shaft, stalk or rotation axis of the door knob.

26. The adapter of claim 25, wherein the portion of the inner surface of the collar clamp includes a material, a coating or other treatment to adapt the inner surface to serve as a gripping surface to promote friction between the inner surface and the supporting shaft, stalk or rotation axis of the door knob.

27. The adapter of claim 26, wherein the material includes a material selected from the group consisting of elastomeric material, rubber, synthetic rubber, adhesive, high friction chemical application, and any combinations thereof.

28. The adapter of claim 25, wherein the portion of the inner surface of the collar clamp includes a textured, scored, knurled, brushed, pitted or other treated surface to promote friction between the inner surface and the supporting shaft, stalk or rotation axis of the door knob.

29. An adapter for a door knob having a supporting shaft, stalk or rotation axis, the adapter comprising:
a lever handle including a base plate and a handle portion;
a screw band attached to the base plate, wherein the handle portion extends transversely to the axis of the screw band;
a finger shell adapted to attach to at least a portion of the door knob, the finger shell including multiple attachment fingers, wherein one or more attachment fingers includes at least a portion of an inner surface adapted to cause the attachment finger and the finger shell to frictionally engage to the portion of the door knob;
the finger shell further adapted to receive the screw band to attach the lever handle to the finger shell; and
a tightening screw attached to the screw band and adapted to tighten or to otherwise adjust the screw band about the finger shell.

30. The adapter of claim 29, wherein the finger shell and the one or more attachment fingers cause the lever handle to have a fixed positive relation to the door knob and its supporting shaft, stalk or rotation axis.

31. The adapter of claim 29, wherein the screw band includes a screw boss attached to the screw band and adapted to house the tightening screw, and wherein the base plate of the lever handle includes an indenture or depression configured to receive at least a portion of the screw boss to connect the screw band to the base plate.

32. The adapter of claim 31, wherein the screw boss provides a path to convey force or torque applied to the lever handle to the door knob.

33. The adapter of claim 29, wherein the finger shell includes one or more registration features, each registration feature being disposed and configured such that at least a portion of the registration feature engages with at least a portion of one of multiple complementary locking features disposed along the base plate to attach the level handle with the finger shell.

34. The adapter of claim 33, wherein the one or more registration features include one or more protrusions or tabs and the complementary locking features including one or more indentures or slots.

35. The adapter of claim 29, wherein the portion of the inner surface of one or more attachment finger includes a material, a coating or other treatment to adapt the inner portion to serve as a gripping surface to promote friction between the inner surface and the door knob.

36. The adapter of claim 35, wherein the material includes a material selected from the group consisting of an elastomeric material, rubber, synthetic rubber, adhesive, high friction chemical application, and any combinations thereof.

37. The adapter of claim 29, wherein the portion of the inner surface of one or more attachment finger is a textured, scored, knurled, brushed, pitted, or other treated surface to promote friction between the inner surface and the door knob.
